(19) United States
(12) Patent Application Publication
(10) Pub. No.: US 2017/0056692 A1
(43) Pub. Date: Mar. 2, 2017

(54) HARNESSES

(71) Applicant: Treemagineers Ltd., Pitlochry (GB)

(72) Inventors: Christopher Sidney COWELL, Pitlochry (GB); Elliot James TANNER, Gwynedd (GB)

(21) Appl. No.: 15/248,513

(22) Filed: Aug. 26, 2016

(30) Foreign Application Priority Data
Sep. 2, 2015 (GB) 1515563.3

(51) Int. Cl. A62B 35/00

(52) U.S. Cl. CPC A62B 35/0006; A62B 35/0037

(57) ABSTRACT

Harnesses for use by a person at height are disclosed. A harness includes a plurality of flexible harness elements, each of which, when in use, encircles part of a user's body. Some or all of the harness elements include a connection piece. A bridge extends between a respective connection piece of two or more harness elements, the bridge extending across a part of a user's body. A connection assembly is connected to the bridge to convey at least part of a user's weight from the harness to a support element. The connection assembly has a coupling element that at least partially surrounds and that can move along the bridge and is capable of loading the bridge at spaced-apart locations. This provides comfort without the need to include any elongate, rigidly-attached component, the presence of which could reduce the flexibility of the harness.

### BACKGROUND TO THE INVENTION

Field of the Invention

This invention relates to harnesses. Specifically, it relates to harnesses that are intended for use by a person at height, such as a climber or a person working at height.

Users who work at height may spend many hours at a time in a harness to perform work tasks on structures, buildings and trees. A typical user will wear an industrial climbing harness and be attached to a climbing system to enable them to position themselves in a location to perform the work tasks required. The harness must not only provide comfortable and safe support for the user, it must also allow the user freedom of movement to climb and maneuver themselves within their working environment.

A commercial user may spend many hours at a time in a harness when working in this way. Therefore, any potential source of discomfort in the harness is likely to lead to actual discomfort over time, which may ultimately lead to a reduction in the time a user can spend working in the harness. It is therefore in both the interest of productivity and of the welfare of the user to ensure that potential sources of discomfort in a work harness are, so far as is possible, minimized.

In general, any part of the harness which is likely to cause a localized increase in the pressure applied to a user's body is a potential source of discomfort, and it is recognized that steps should be taken in designing a harness to avoid any potential source of raised pressure.

Summary of the Prior Art

One approach to solving this problem is to provide a rigid or semi-rigid platform that acts as a seat to provide the primary support for a user's weight. For example, this arrangement can be seen in US-A-2009/314578. Comfort may potentially be further improved by providing a bosun's chair arrangement that provides a broad and potentially cushioned sitting platform. However, the presence of a rigid structure in both of these arrangements can restrict a user's freedom of movement, and can be unwieldy when working in a partially-obstructed space, such as amongst branches of a tree canopy or maneuvering through a manhole. Therefore, many users still prefer a fabric harness made of flexible material including ropes and webbing.

To place the invention in context, a known harness to which it might be applied is shown in FIGS. 1 and 2. The main components of such a harness include a waist belt 10, leg loops 12, a bridge 14, an attachment eye 16, top Ds 18 and forward Ds 20. The bridge 14, which in this example is a length of fabric rope, extends between eyes on the respective forward Ds and the attachment eye 16 surrounds and can slide along the bridge 14.

For use, a user is secured within the harness with the waist belt 10 around their waist, and with each leg loop 12 surrounding a respective one of the user's thighs. In this position, each forward D 20 lies to the outside of the user's leg 26. A climbing rope 28 is connected to the attachment eye 16, typically by way of a carabiner, to carry the user's weight through the leg loops 12. The attachment eye 16 can float along and pivots upon the bridge 14 when the user moves from side to side. This gives the user unrestricted movement and means the harness adapts to the users shape when they twist, pivot and move, which is considered by users to be a particular advantage of this type of harness.

A problem arises with this arrangement because the bridge 14 extends in two lengths from the attachment eye 16, so that the force applied to each of the forward Ds 20 has an inward component Fᵢ that is directed towards the other of the forward Ds 20 as well as a force Fₒ that acts away from the user. This is shown diagrammatically in FIG. 3A. Such harnesses are wrapped around a user, with a U-shaped rear part applying the load to the user. When loaded from the ventral attachment point, the harness compresses the width of the loaded U shape, reducing the loaded contact area and compressing the body of the user. This inward component can result in localized pressure, and possible discomfort after long-term use. Therefore, known harnesses put stress and pressure on the user due to constricting the user's hips, legs and buttock area when under load due to the single attachment eye point which is of limited width. One attempted solution is to add a seat to the rear of the harness, as illustrated in FIG. 3B, however there is still discomfort because of the rigid nature of the seat. Moreover, harness seats are cumbersome and can restrict the movement and rope positioning ability of the user due to the position behind the legs and rigid nature of the seat.

An improvement to this type of harness is disclosed in EP-A-2 781 235. This proposes making a rigid interconnection between what is called here the forward Ds. However, this requires an extended, rigid component to be connected to the harness, which can restrict a user's freedom of movement and which removes some of the flexibility that is appreciated in this type of harness.

### SUMMARY OF THE INVENTION

An aim of this invention is to avoid or reduce this potential disadvantage without compromising the flexibility of this type of harness.

To this end, from a first aspect, this invention provides a harness for use by a person at height comprising:
a plurality of flexible harness elements, each of which, when in use, encircles part of a user's body, wherein some or all of the harness elements include a connection piece;
a bridge extending between a respective connection piece of two or more harness elements, the bridge extending across a part of a user's body;
connection means connected to the bridge to convey at least part of a user's weight from the harness to a support element; wherein:
the connection means has coupling means that at least partially surrounds and that can move along the bridge and is capable of loading the bridge at spaced-apart locations.

The aim of improving comfort is thereby achieved, without the need to provide any elongate, rigidly-attached component, and thereby maintain the flexibility of the harness.

The bridge is typically an elongate flexible component, intended to be loaded under tension. It may take a wide variety of forms, being, for example, formed from rope (wire or textile), webbing, cable, or otherwise.

The coupling means may be capable of distributing load along a length of the bridge that is a substantial proportion of the dimension of a user's body that is spanned by the bridge: that is to say, it may exceed 10%, 20%, 25%, 50% or 100% of that dimension. For example, where the bridge extends across a user's trunk or hips, the coupling means may spread its load over a distance in the range of 100 mm to 500 mm or more.

For example, the coupling means may have a tubular body through which the bridge extends. In such a case, the load is spaced apart on the bridge by the length of the tubular body. Alternatively, the coupling means may have a plurality of spaced guides through which the bridge passes. In such a case, the load is spaced apart on the bridge by the distance between the guides. The bridge makes sliding or rolling contact with the body while the harness is in use, which can cause parts of the body to wear over time. Therefore, it may be advantageous for those parts of the body with which the bridge makes contact may be formed as separate components that can be removed and replaced independently of other parts of the harness. Advantageously, each of these components may be configured such that it can be connected to the coupling means in a plurality of orientations such that if excessive wear occurs at one part of the component, it can be removed from the body and re-installed in a different orientation, whereby an unworn part of the component makes contact with the bridge.

In some embodiments of the invention, the coupling means is capable of loading the bridge at spaced-apart locations when in a first configuration, and in a second configuration, loads the bridge at closely-spaced locations. This allows a user to choose between maximizing comfort and maximizing freedom of movement. For example, such embodiments (or others) may have loading components, such as loading arms, each of which carries a loading element, the distance between the loading elements determining the extent to which the load is spaced along the bridge. These loading components may be mutually movable (e.g., by pivoting, sliding, screwing, or moving telescopically) to adjust the spacing between the loading elements.

In these embodiments, due to the large loads apparent on the spaced-apart locations, a load-limiting means may be provided to enable the device to break non-catastrophically in the event that the load exceeds a safe threshold. The load-limiting means may include a breaker bolt or breaker link that will fail at a predetermined force to return to the second, closely-spaced and thus stronger configuration to enable a non-catastrophic collapse of the device. This may give the user the ability to carry on using the device in the closed position whilst being rescued or performing self-rescue. Thus, when in the first configuration, a load on the bridge exceeds a threshold, the loading components are caused to move towards their second configuration.

The connection means typically includes linking means that can be used to link the connection means to an external component, such as a carabiner or a sling. Most advantageously, the connection means permits pivotal movement between the connection means and the external component. Such pivotal movement is preferably permitted about more than one axis. Such axes are preferably normal to and parallel to the bridge in the region of the connecting means.

Preferably, contact between the bridge and the connection means is made through components configured to minimize friction and/or abrasion with the bridge. For example, contact between the bridge and the connection means may be made through rolling elements or through smooth and/or curved surfaces.

The support element is typically a climbing line.

Embodiments of the invention will now be described in detail, by way of example, and with reference to the accompanying drawings.

### BRIEF DESCRIPTION OF THE DRAWINGS

FIGS. 1 and 2 show a conventional harness to which embodiments of the present invention might be applied, and have already been discussed;

FIGS. 3A and 3B are diagrams that show forces acting within the harness of FIGS. 1 and 2;

FIGS. 4 and 5 are side and end views of a load-spreading assembly being a component of an embodiment of the invention;

FIG. 6 is a cross-sectional view of the load-spreading assembly of FIGS. 4 and 5;

FIG. 7 is a diagonal view of the load-spreading assembly of FIGS. 4 and 5 showing it in place on a rope;

FIG. 8 is a view of the load-spreading assembly of FIGS. 4 to 6 in an alternative configuration;

FIG. 9 is a diagram equivalent to FIG. 3 that shows forces acting within the harness that is an embodiment of the invention;

FIGS. 10, 11 and 12 are diagonal views of a load-spreading assembly being a component of an alternative embodiment of the invention in closed and open configurations, FIGS. 11 and 12 showing opposite sides of the assembly;

FIGS. 13 and 14 show a further embodiment of the invention in a first configuration;

FIG. 15 shows the embodiment of FIGS. 13 and 14 in a second configuration;

FIGS. 16 and 17 show a further embodiment of the invention in a first configuration;

FIGS. 18 and 19 show the embodiment of FIGS. 14 and 15 in a second configuration;

FIGS. 20 and 21 show a variation of the embodiment of FIGS. 4 to 8;

FIG. 22 is an exploded view of the embodiment of FIGS. 20 and 21; and

FIGS. 23 and 24 show a variation that can be applied to embodiments of this invention.

### DETAILED DESCRIPTION OF THE PREFERRED EMBODIMENTS

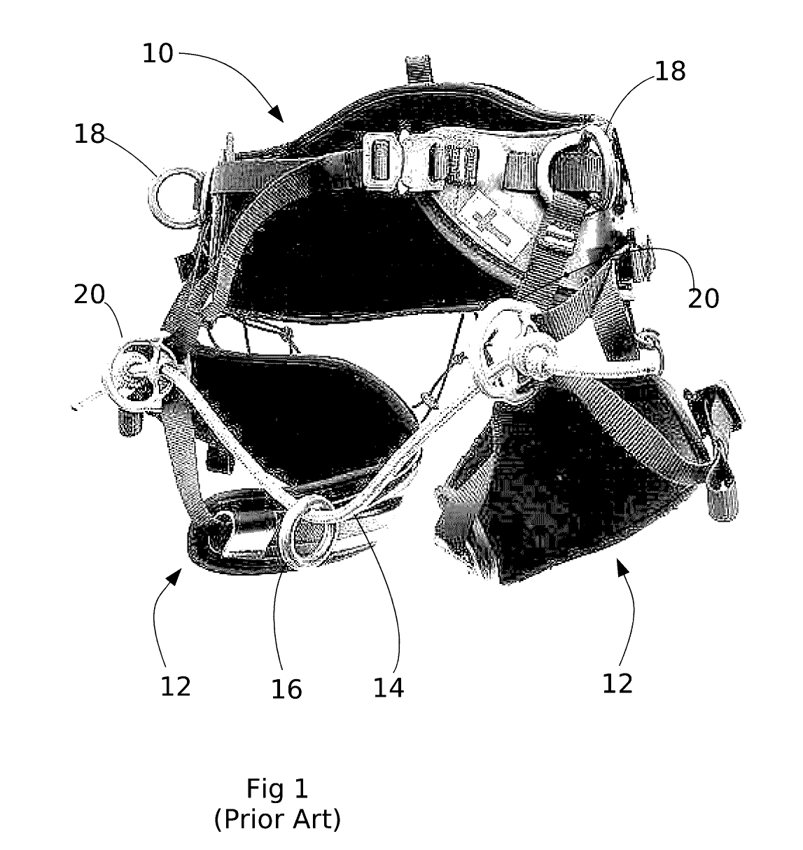

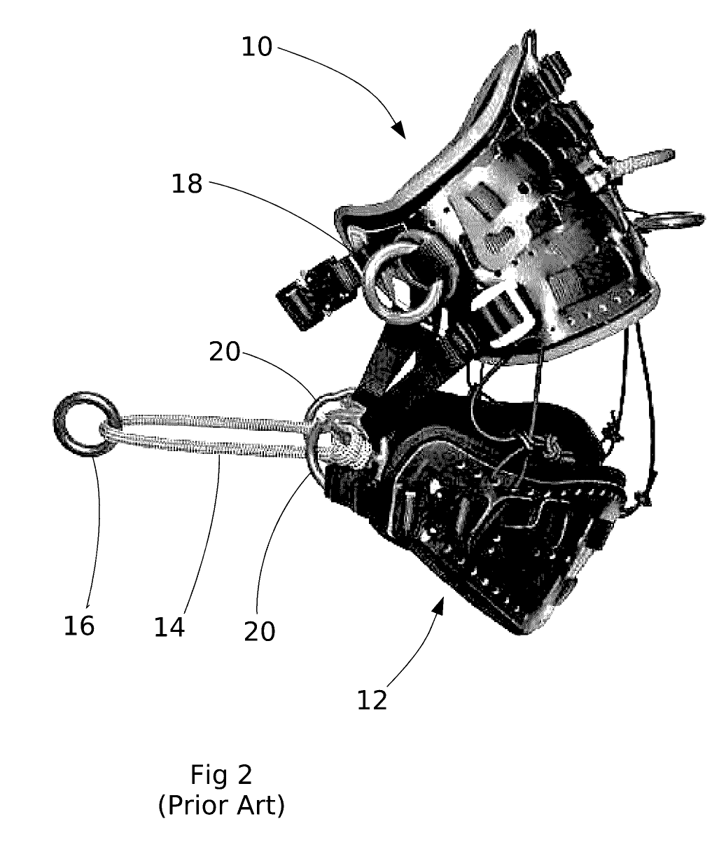

With reference to the drawings, an embodiment of the invention is a modification of the harness of FIGS. 1 and 2 and should be assumed to include all of the components of that harness. This embodiment comprises all of the components of that harness, with the exception of the attachment eye 16, which is replaced by a load-spreading assembly, as will now be described.

The load-spreading assembly comprises a tubular body 30 which, in this embodiment, is formed from light alloy by forging, machining and/or casting. The body has a central, cylindrical passage 32 that extends lengthways, parallel to a long axis A, through it. End portions 34 of the cylindrical passage 32 are radiused, so as to present no sharp edges and reduce frictional forces in movement at the ends of the passage 32. The length of the passage in this embodiment is approximately 120 mm, but this may be varied to accommodate users of different sizes and a range of applications and working environments.

Centrally along the length of the body there is an attachment point. The attachment point comprises a swivel connector 40 and two flange portions 42 of the body 30.

The flange portions 42 have facing surfaces that are spaced apart and parallel to one another to opposite sides of the axis A. Centrally, an aperture is formed through each flange portion 42, these apertures being coaxial and transverse to the axis A. In the region of the flange portions 42, the passage 32 is open in a direction radially of the axis; however, this is for convenience of manufacture, and is not an essential feature of embodiments of this invention.

The swivel connector 40 comprises a boss 46 and an eye 50, these being interconnected for free mutual rotation about a swivel axis B. The boss 46 has spaced parallel surfaces, and an aperture that extends through the boss between them (not shown). A pivot bolt 52 passes through the apertures in the flange portions 42 and the boss 46 and is retained by a nut 54 recessed into one of the flange portions 42. This allows the boss 46, and therefore the entire swivel connector 40, to pivot about a pivot axis C that is coaxial with the pivot bolt 52, as shown in FIG. 8.

In use, the bridge 14 of the harness passes through the cylindrical passage 32. A climbing rope is connected to the swivel connector, typically through a carabiner that passes through the eye 50. As with the conventional harness, the position of the climbing rope can pivot and float with respect to the bridge by:

the tubular body 30 sliding along the bridge 14, free sliding being ensured by the provision of the radiused end portions 34;

the swivel connector 40 pivoting with respect to the body 30 about the axis C; and

the eye 50 pivoting with respect to the boss 46, and therefore the body 30, about the swivel axis B.

This allows a similar freedom of movement as does a conventional harness.

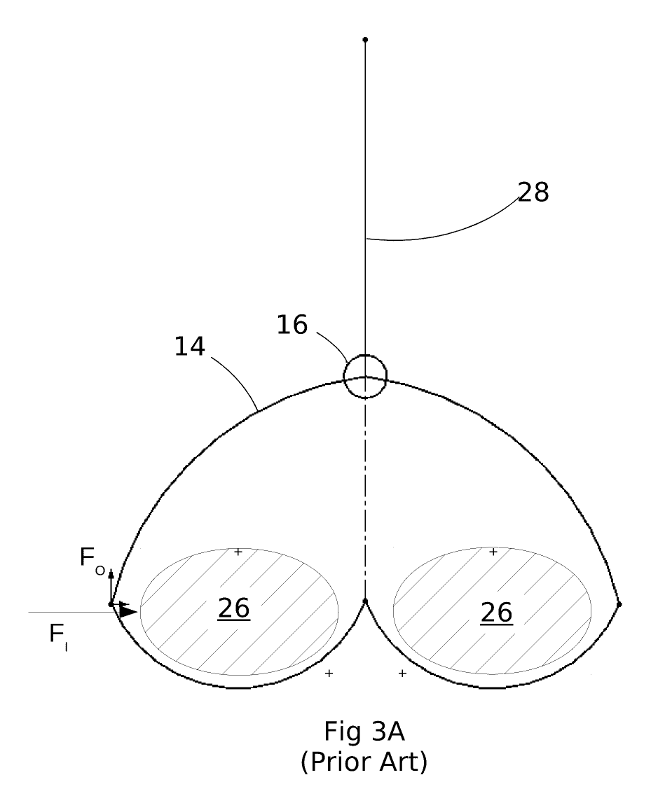

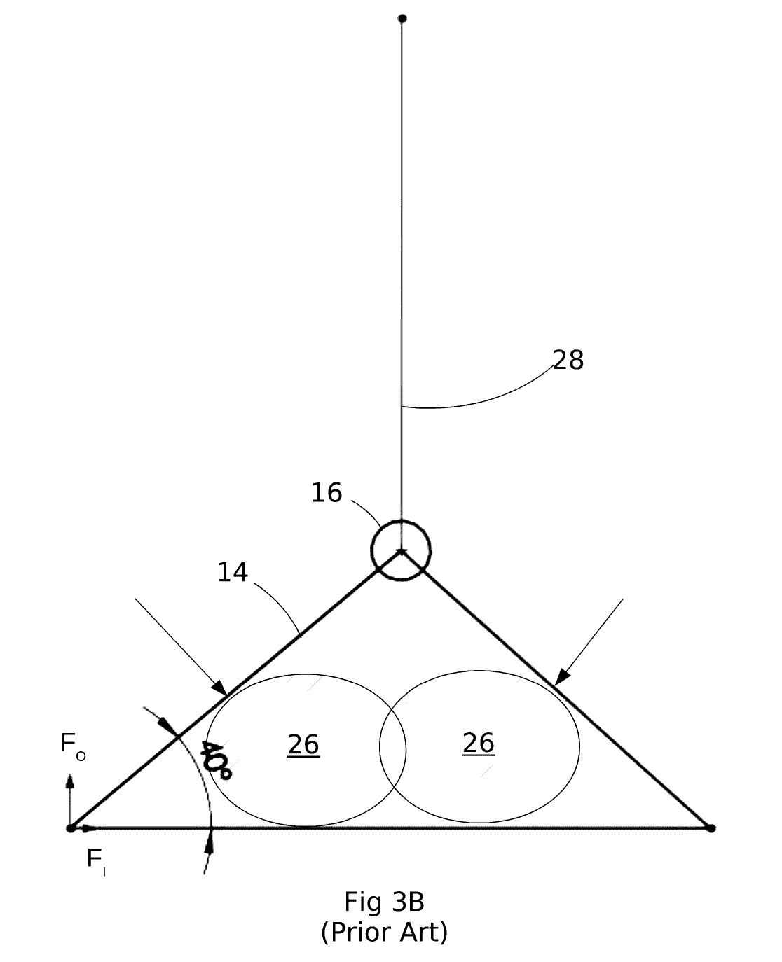

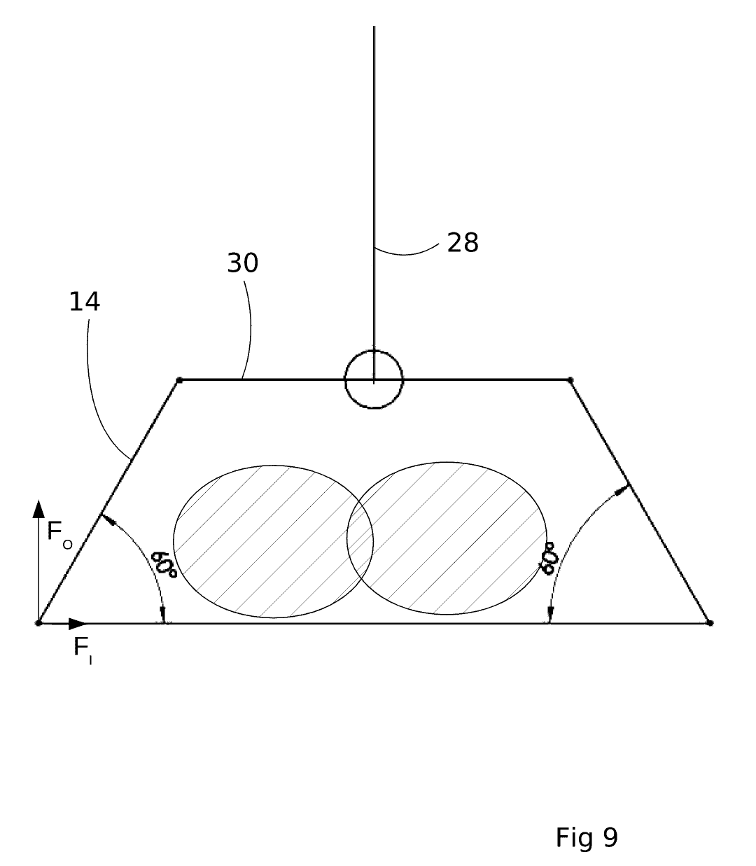

As can be seen by comparing FIGS. 9 and 3, the effect of this invention is that the component of the force in the bridge 14 that is resolved into an inwardly-directed force Fᵢ is reduced, and that the end potions of the bridge, which extend from the forward Ds 20, are held at an angle which causes less or no compression to the user's legs. The effect of this is to lessen pressure that is applied to a user's body during use of the harness, and thereby reduce the likelihood that it will cause discomfort.

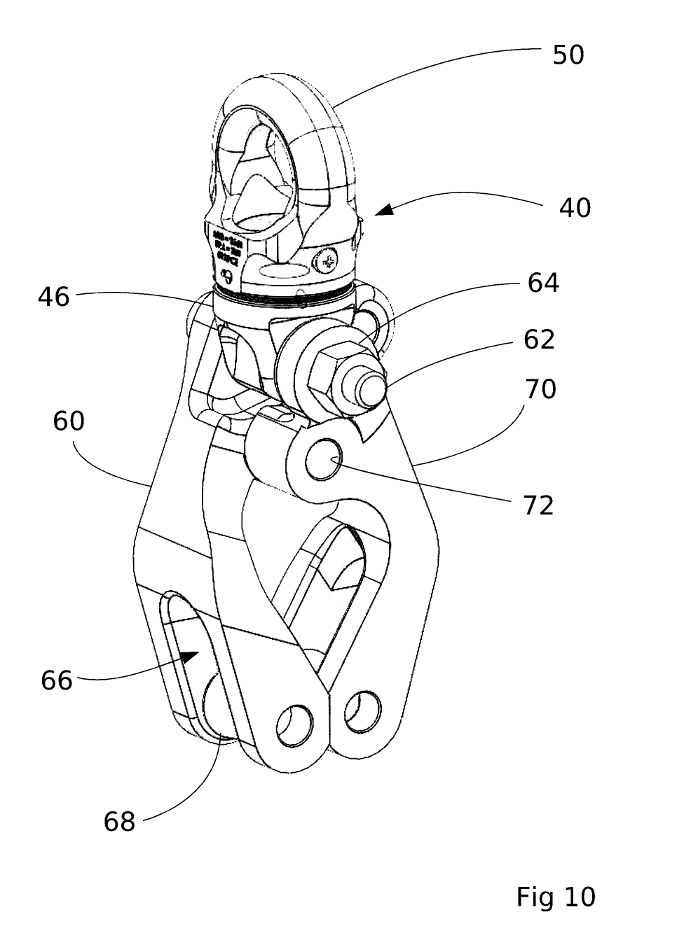

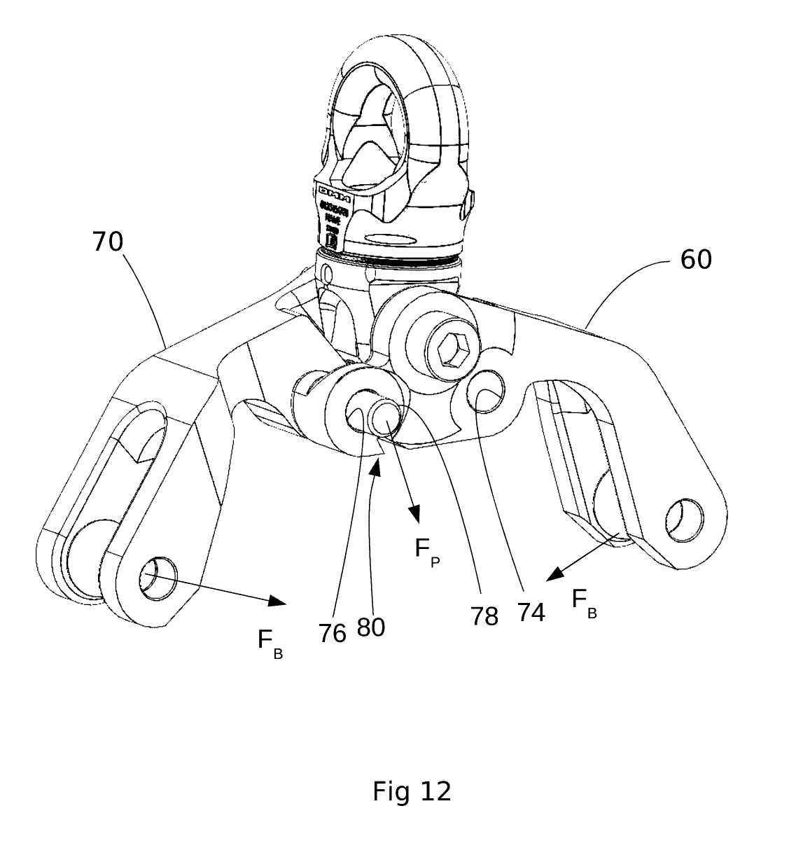

An alternative embodiment of the invention is shown in FIGS. 10, 11 and 12. This embodiment includes a swivel connector 40 essentially the same as that described above.

In this embodiment, first and second arms 60, 70 are pivotally connected by a pivot bolt 62 and nut 64 to the boss 46 such that each arm 60, 70 can pivot against a respective one of the spaced parallel surfaces of the boss 46. Remote from the pivot bolt 62, the arms fork, whereby a passage 66 through each arm is defined in a direction normal to the pivot axis C. Each passage 66 is closed by a cross-piece 68 of circular cross-section that extends across the fork parallel to the pivot axis C. A transverse bore 72 extends through the second arm 70 parallel to and close to the pivot bolt. Two bores 74, 76 extend through the first arm 60 parallel to and close to the pivot bolt.

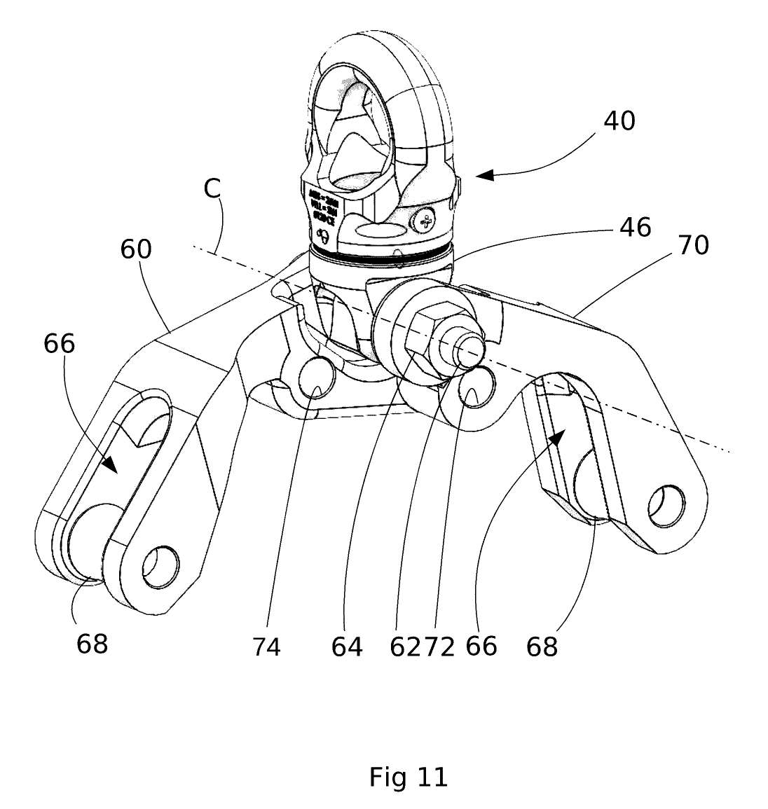

The arms 60, 70 can be disposed in a closed position (FIG. 10) in which they are pivoted together about the pivot bolt 62 to reduce to a minimum the distance between the passages 66. In this position, the bore 72 of the second arm is in alignment with one of the bores 74 in the first arm 60, and a pin can be inserted into these bores 72, 74 to secure the arms 60, 70 in that position. Alternatively, the arms 60, 70 can be disposed in an open position (FIG. 11) in which they are pivoted apart about the pivot bolt 62 to maximize the distance between the passages 66. In this position, the bore 72 of the second arm is in alignment with the other one of the bores 76 in the first arm 60, and a pin can be inserted into these bores 72, 76 to secure the arms 60, 70 in the open position.

In use, the bridge 14 of the harness passes through the passages 66 in the two arms 60, 70. A climbing rope is connected to the swivel connector, typically through a carabiner that passes through the eye 50. The bridge 14 can slide through the passages 66 and over the cross-pieces 68. While in use, a user can move the arms 60, 70 between their closed and their open position as required. In the closed position, a small attachment width on bridge 14 is created to maximize a user's freedom of movement. In the open position, the connection with the bridge is larger, thereby increasing the comfort of the harness.

The cross pieces 68 may include rollers to reduce the friction applied by the arms as they pass along the bridge 14. Another consequence of this to reduce wear on the bridge 14. A similar arrangement may be provided in other embodiments.

It will be seen that when the harness is bearing a user's weight and the arms 60, 70 are in the open position, the forces F_{B} applied to the arms 60, 70 by the bridge 14 urge them towards the closed position, this force being resisted by the pin 78 and the material surrounding the bores 72, 76. In many embodiments of this general configuration, the assembly as a whole will be strongest when the arms 60, 70 are in the closed position. Therefore, it may be advantageous for the assembly to be configured such that the arms 60, 70 return to the closed condition if normal service loading is exceeded, and well before loading on the assembly approaches an ultimate maximum load.

In this embodiment, a break-out portion 80 of the material of the first arm 60 that surrounds the bore 76 used when the arms 60, 70 are in the open position is of reduced thickness. The break-out portion 80 is located at the part of the first arm 60 that react force F_{P} with the pin 78. The pin 78 will be driven though break-out region 80 in the event that the force F_{B} applied by the bridge 14 to the arms 60, 70 exceeds a threshold. With careful design of the thickness and position of material, this can be caused to happen at loads significantly below the ultimate failure load of the assembly (but in excess of that encountered in normal use) and relatively progressively, as compared with catastrophic failure that might occur in the event of breakage under extreme loading.

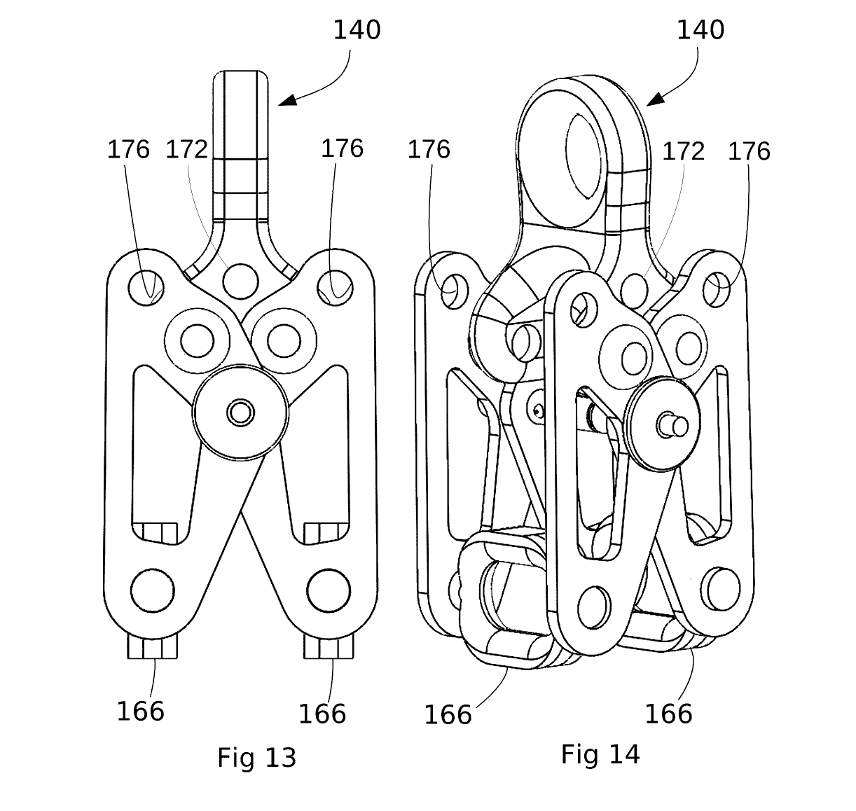

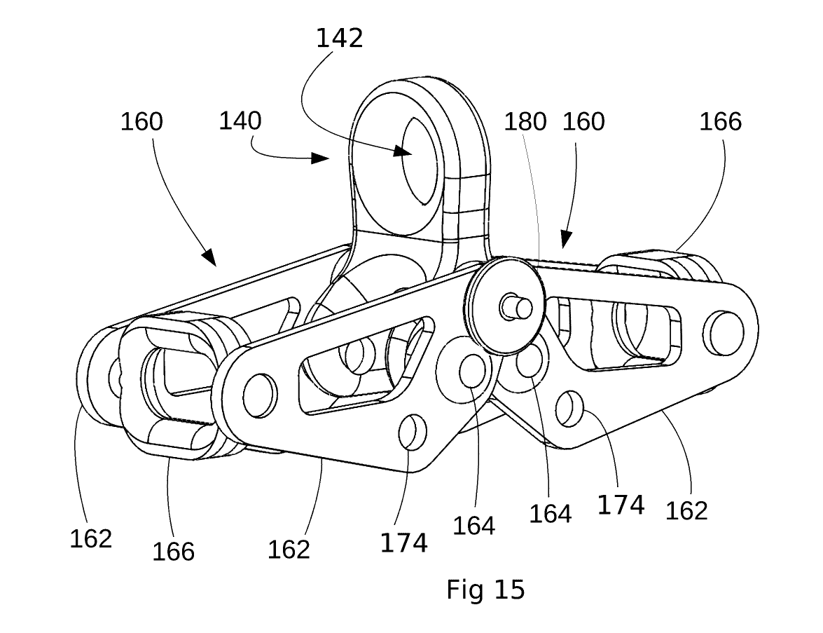

The embodiment of FIGS. 13 to 15 is functionally similar to that of the embodiment of FIGS. 10 to 12. In this embodiment, two arms 160 are pivotally connected to a central boss 140 that has a securing eye 142. Although the boss 140 shown is a one-piece, solid component, it could equally be of a swiveling type, as described above.

The arms 160 each comprises two parallel side plate members 162 connected to opposite sides of the boss 140 by a pivot 164 whereby the arms can pivot with respect to the boss 140 about respective parallel pivot axes. A guide ring 166 interconnects the arms 162 remote from the pivots, the guide ring 166 being free to pivot with respect to the arms 160 about an axis parallel to the pivot axes of the arms 160. The guide rings 166 each have a rounded square shape and have inwardly convex curved surfaces to allow smooth passage of the bridge through them. The pivotal attachment of the guide rings 166 to the arms 160 ensures that they always adopt an alignment that allows free passage of the bridge 14 though them.

The plate members 162 have first and second apertures 174, 176 with align with a transverse bore 172 in the boss 140 with, respectively, the arms 160 in a closed and an open position. To retain the arms 160 in either position, a pin 180 is inserted through the apertures 174 or 176, as the case may be, and the bore 172. The pin 180 can be selected to have a strength that will cause it to fail in the event that the load applied to the arms 160 by the bridge exceeds a threshold, thereby allowing the arms 160 to return to the closed position.

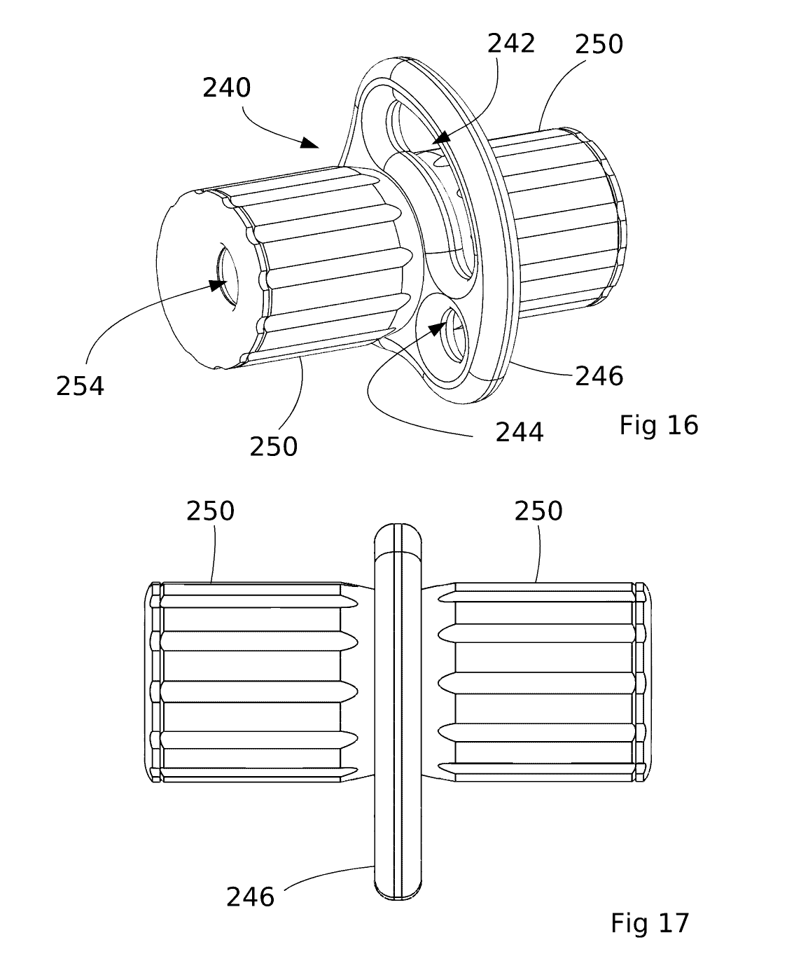

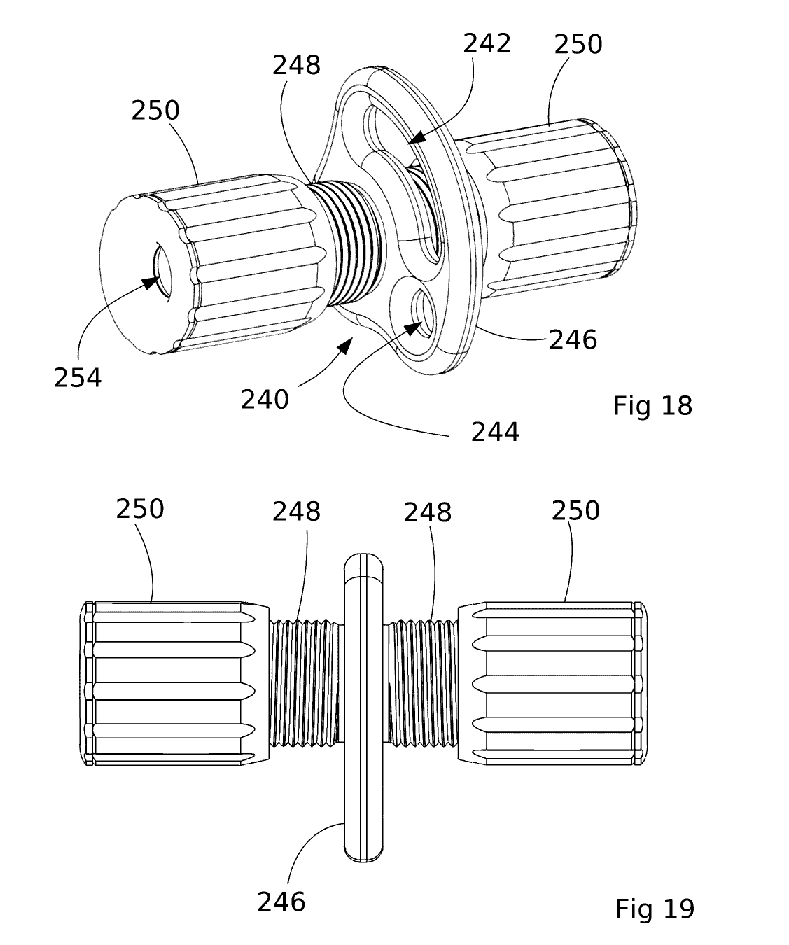

The embodiment of FIGS. 16 to 19 comprises a central boss 240 with two (in this case) securing eyes 242, 244 carried on a transverse flange portion 246. Coaxial externally-threaded spigots 248 extend from the flange portion 246, each having an axial through passage that also extends through the flange portion 246. A respective sleeve 250 is carried on each of the spigots 248, the sleeve having an internal thread in engagement with the thread of the spigot 248. An outer face of each sleeve has an opening 254 in communication with its interior, the opening being surrounded by a concave curved surface.

In use, the bridge 14 is passed through the sleeves 250 and the boss 240. The length of the loading applied to the bridge 14 is determined by the distance between the openings 254 of the sleeves 250, which can be adjusted by rotation of the sleeves 250 with respect to the boss to cause them to move axially along the spigots 248. It may be advantageous for the threads of the two spigots 248 (and so, of the sleeves 250) to be of opposite hands, whereby the same action on the part of a user causes the same effect (lengthening or shortening) to each of the sleeves.

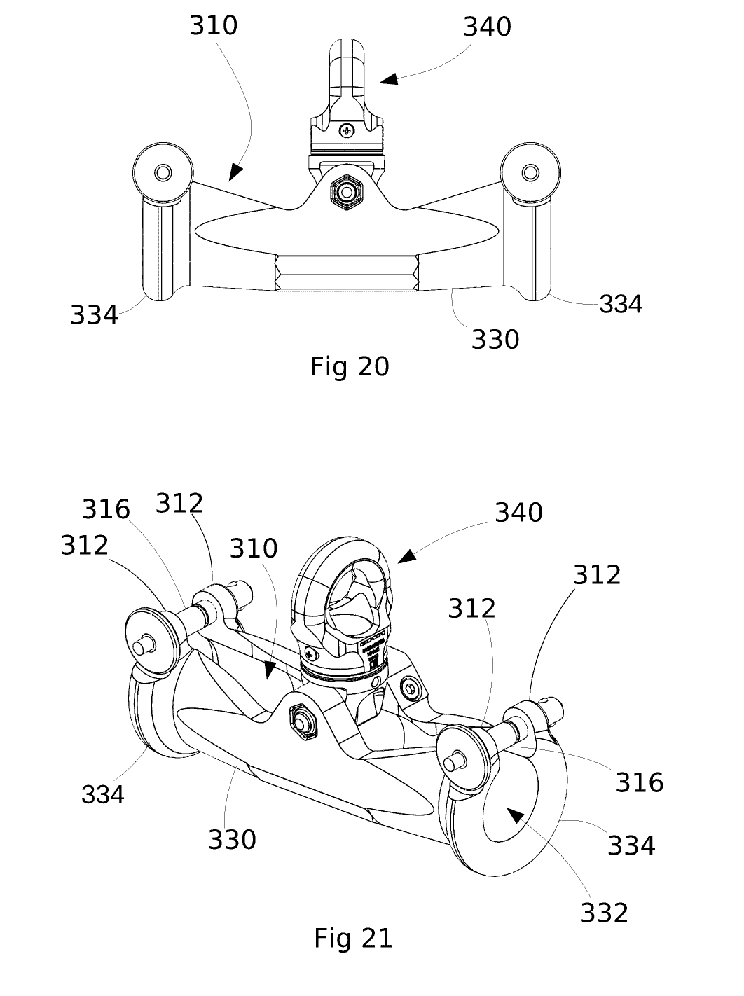

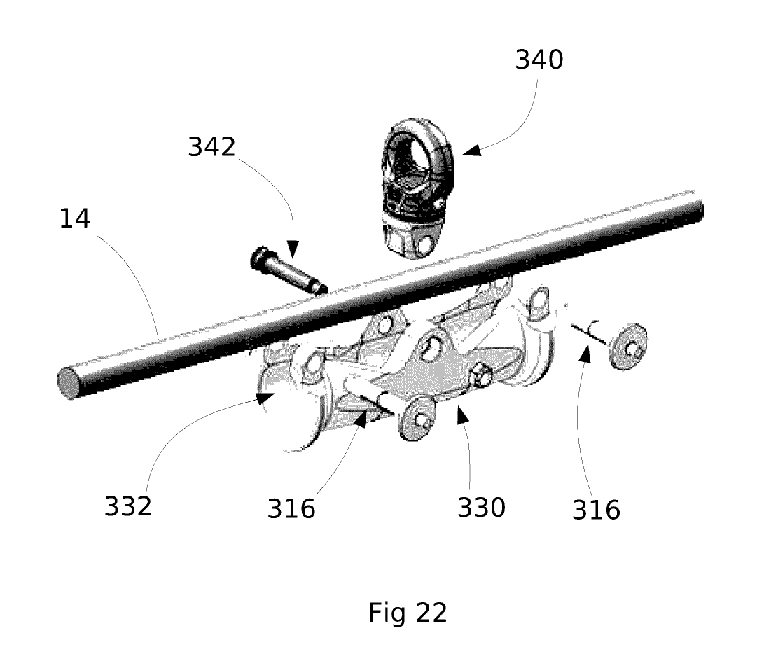

A variation on the first embodiment of the invention is shown in FIGS. 20 to 22. In this embodiment, a slot 310 extends radially through each tubular passage 332 of the body 330. Thus, the body is generally U-shaped in section. In the region of the end portions 334 of the tubular passage, flanges 312 project form the body, parallel and facing one another to opposite sides of each slot 310. A bore extends through each flange 312, the bores of each pair of flanges 312 being coaxial. A closing pin 316 is provided at each end portion 334. In a closed condition, the closing pin 316 passes through both bores. The swivel connector 340 is secured between the flanges by a removable pivot pin 342.

With the pins 316 in the closed condition, and the swivel connector 340 retained by the pin 342, a rope bridge passing through the body 30 is retained within the body 330 and a harness to which the load spreading assembly is attached will operate in the same way as the first embodiment. In an open position, each closing pin 316 is withdrawn, and both bores and the pivot pin 342 are removed to allow the swivel connector to be separated from the body 330. In this configuration, a rope bridge 14 or other connecting element can pass into or out of the body 330. This allows the apparatus to be applied to or removed from a harness without the need to free one end of the rope bridge.

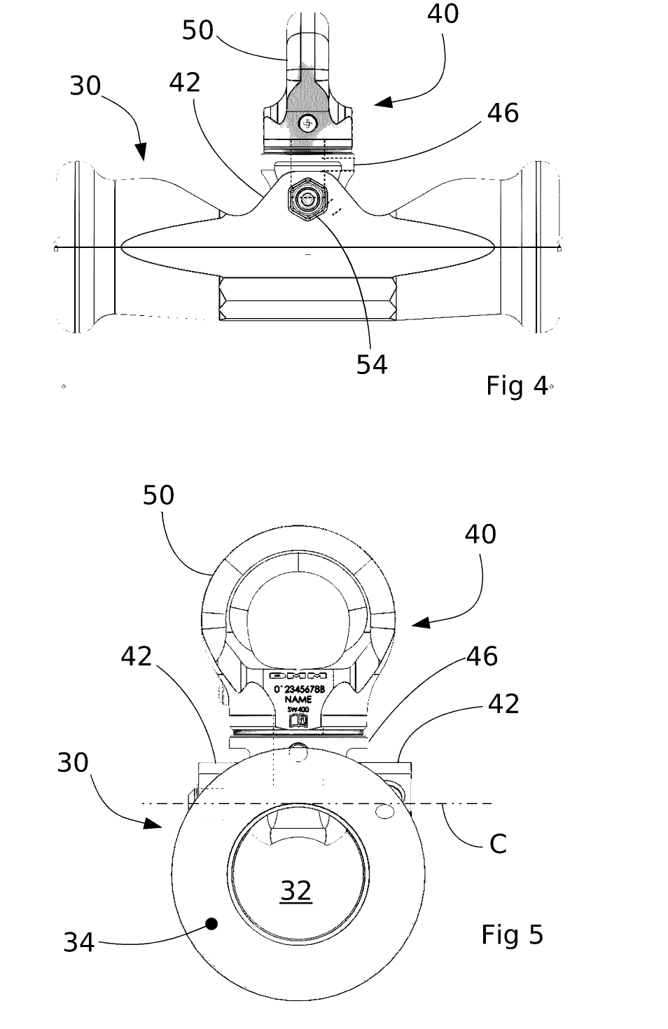

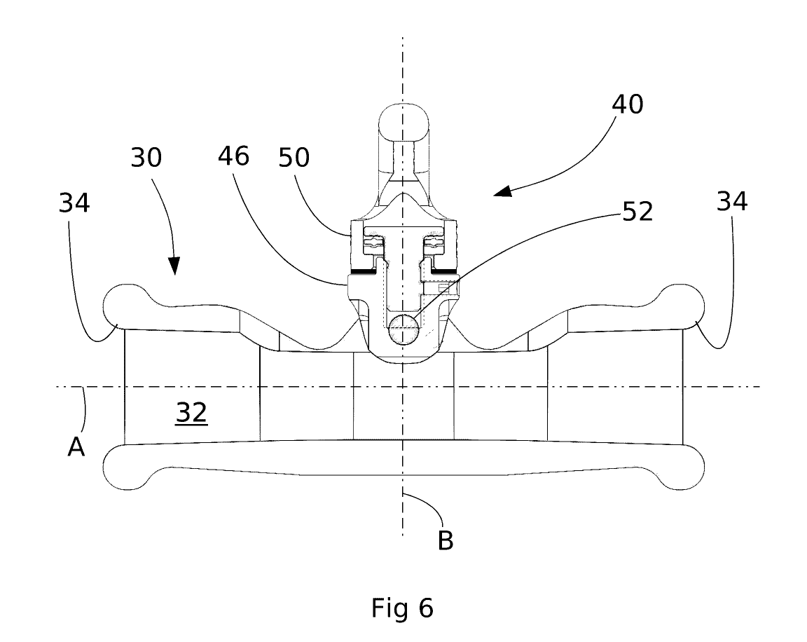

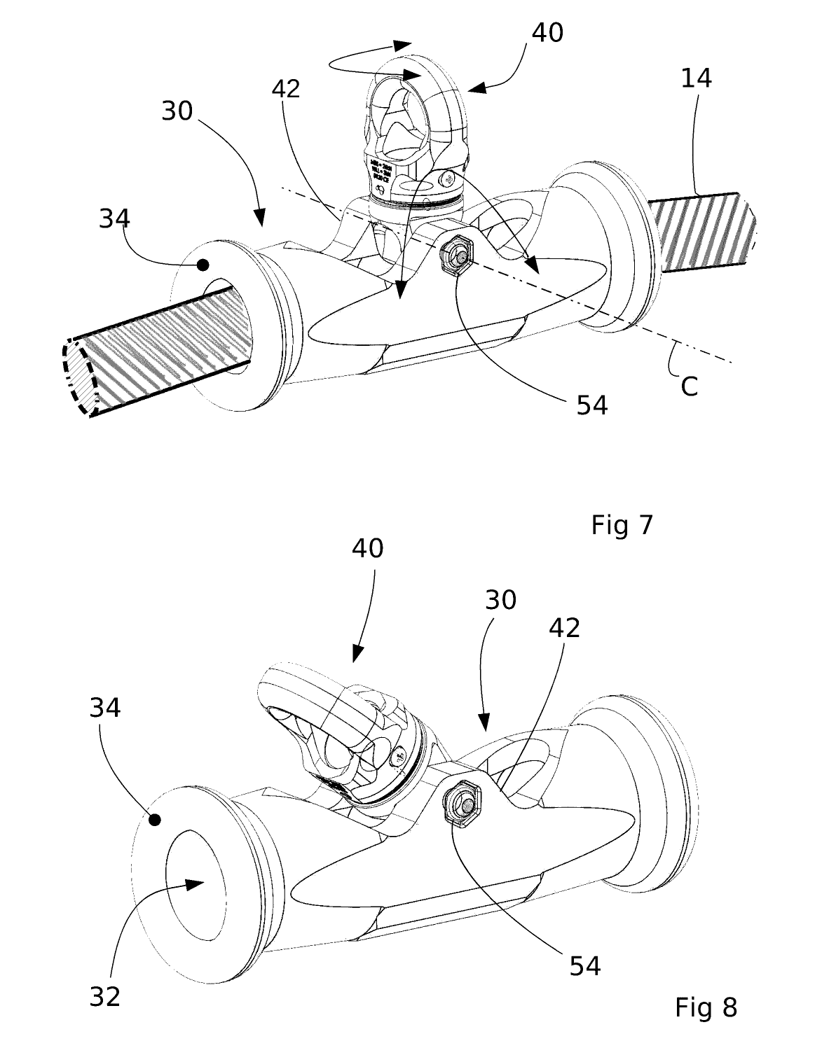

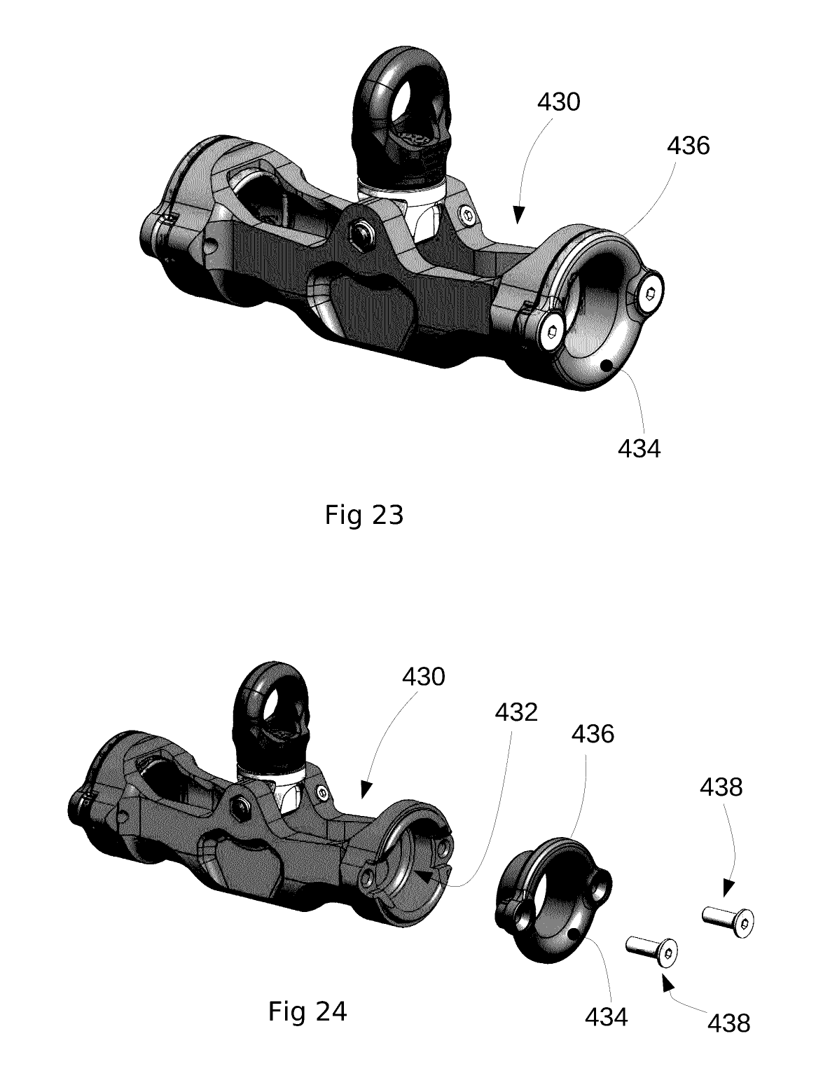

With reference now to FIGS. 23 and 24 there is shown a modification that can be applied to many of the embodiments described above. This particular implementation of the modification is a variation of the embodiment of FIGS. 4 to 8, but the skilled person will readily understand how it could be applied to other embodiments.

In this modification, the end portions 434 of the tubular body 430 are formed on separate annular components 436. Each annular component has a central opening that, at an inner end, connects with one end of the cylindrical passage 432, and, extending outwardly from there, is radiused so as to present no sharp edges and reduce frictional forces in movement of a rope or other element extending out of the end of the passage 432. This is exactly the same function as described with reference to the end portions 34 of the first embodiment.

The annular components 436 are each secured to the tubular body 430 by several (two, in this embodiment) cap screws 438 that pass through the annular components 436. The stem of each cap screw 438 is received in a tapped hole in an end surface of the tubular body 430, and the head of each cap screw 438 is received in a recess in the annular component.

The annular components 436 are rotationally symmetrical. If, during use, wear occurs on part of an annular component 436 through rubbing contact with the bridge 14, it can be removed from the body 430, rotated and re-attached such that a different, unworn part of the annular component 436 makes contact with the bridge 14. The annular components 436 can be replaced independently of other components of the harness in the event that wear has occurred at all possible angular locations.

1-23. (canceled)

24. A harness for use by a person at height comprising:
a plurality of flexible harness elements, each of which, when in use, encircles part of a user's body, wherein some or all of the harness elements include a connection piece;
a bridge extending between a respective connection piece of two or more harness elements, the bridge extending across a part of a user's body;
a connection assembly connected to the bridge to convey at least part of a user's weight from the harness to a support element; wherein:
the connection assembly has a coupler that at least partially surrounds and that can move along the bridge and is capable of loading the bridge at spaced-apart locations.

25. The harness according to claim 24, wherein the bridge is an elongate flexible component, intended to be loaded under tension.

26. The harness according to claim 25, wherein the bridge is formed from one or more of wire rope, textile rope, webbing or cable.

27. The harness according to claim 24, wherein the coupler is capable of distributing load along a length in excess of 10%, 20%, 25%, 50% or 100% of the dimension of a user's body that is spanned by the bridge.

28. The harness according to claim 24, wherein the coupler is capable of distributing load along a length of 100 mm to 500 mm.

29. The harness according to claim 24, wherein the coupler has a tubular body through which the bridge extends.

30. The harness according to claim 24, wherein the coupler includes a plurality of spaced guides through which the bridge passes.

31. The harness according to claim 24, wherein those parts of the coupler with which the bridge makes contact are formed as separate components that can be removed and replaced independently of other parts of the harness.

32. The harness according to claim 31, wherein each separate component is configured such that it can be connected to the coupler in a plurality of orientations such that if excessive wear occurs at one part of the component, it can be removed from the body and re-installed in a different orientation whereby, in subsequent use, an unworn part of the component makes contact with the bridge.

33. The harness according to claim 24, wherein the coupler is capable of loading the bridge at spaced-apart locations when in a first configuration, and in a second configuration, at locations that are spaced apart by a distance that is less than in the first configuration.

34. The harness according to claim 33 having loading components, each of which carries a loading element, the distance between the loading elements determining the extent to which the load is spaced along the bridge.

35. The harness according to claim 34, wherein the loading components are mutually movable to adjust the spacing between the loading elements.

36. The harness according to claim 35, wherein the loading components are mutually pivotable with respect to one another.

37. The harness according to claim 35, wherein the loading components are in threaded engagement with one another or with a common linking component.

38. The harness according to claim 33 which, when in the first configuration, a load on the bridge exceeds a threshold, the loading components are caused to move towards their second configuration.

39. The harness according to claim 24, wherein the coupler has a closure that can be opened to remove or introduce the bridge from or to the coupler.

40. The harness according to claim 24, wherein the connection assembly includes a linkage means that can be used to link the connection assembly to an external component.

41. The harness according to claim 40, wherein the connection assembly permits pivotal movement about axes that are normal to and parallel to the bridge in the region of the connection assembly between the connection means and the external component.

42. The harness according to claim 41, wherein the pivotal movement is permitted about more than one axis.

43. The harness according to claim 42, wherein the axes are normal to and parallel to the bridge in the region of the connection assembly.

44. The harness according to claim 24, wherein contact between the bridge and the connection assembly is made through components configured to minimize friction and/or abrasion with the bridge.

45. The harness according to claim 44, wherein contact between the bridge and the connection assembly is made through rolling elements.

46. The harness according to claim 44, wherein contact between the bridge and the connection assembly is made through smooth curved surfaces.
